(19) United States
(12) Patent Application Publication
(10) Pub. No.: US 2026/0220882 A1
(43) Pub. Date: Jul. 30, 2026

(54) System and Method for Dynamic Shadow Generation and Rendering in a Mixed Reality Environment

(71) Applicant: Flying Flamingos India Private Limited, Bangalore (IN)

(72) Inventors: Amit Gaiki, Bangalore (IN); Shourya Agarwal, Ajmer (IN); Avijit Kundal; Yaswanth NSN, Andhra Pradesh (IN)

(73) Assignee: Flying Flamingos India Private Limited, Bangalore, KA (IN)

(21) Appl. No.: 19/436,004

(22) Filed: Dec. 30, 2025

(30) Foreign Application Priority Data
Dec. 30, 2024 (IN) 202441104502

(51) Int. Cl. G06T 15/60; G06T 19/00; G06V 10/60

(52) U.S. Cl. CPC G06T 15/60; G06T 19/006; G06V 10/60

(57) ABSTRACT

The present disclosure relates to a system and method for dynamic shadow casting in mixed reality environments. The system receives an image of a physical environment from one or more sensors, analyzes the image to derive lighting and spatial features, and generates a depth map. A shadow detection model identifies shadow regions and classifies the scene into a first shadow-type (directional) or a second shadow-type (diffused). Based on the classification, illumination parameters including light direction, intensity, and diffusion are generated. Virtual light sources derived from the parameters are placed within a three-dimensional rendering environment, and digital objects are rendered and aligned with the physical scene. The system casts one or more shadows of the digital objects and composites the rendered scene with the physical image to create an augmented image consistent with real-world lighting.

### TECHNICAL FIELD

The present disclosure relates to the field of computer vision and mixed-reality rendering. More particularly, the present disclosure pertains to a system and a method for generating illumination-aware rendering of digital content within a physical environment.

### BACKGROUND

Mixed reality environments require seamless integration of digital content into real-world scenes. The digital content should appear consistent with surrounding lighting conditions. Conventional mixed-reality systems often rely on static assumptions of light direction or use generalized brightness estimation techniques. However, the conventional systems fail to capture complex lighting behaviour, such as multiple illumination sources, diffused shadows, or reflections. As a result, rendered digital objects frequently appear visually disconnected from the environment. The rendered digital objects exhibit incorrect shading, unrealistic shadow softness, or inconsistent brightness.

Existing illumination-mapping techniques typically depend on dedicated hardware sensors or precomputed environmental maps. The existing techniques limit adaptability in dynamic lighting situations, such as moving clouds, indoor transitions, or artificial light flicker. Moreover, the existing systems lack real-time correlation between detected shadows and physical geometry, which leads to photometric mismatch and inaccurate shadow projection.

Therefore, there is a need for a solution to render and composite digital objects that exhibit photometric consistency with the physical scene.

### SUMMARY

In an aspect, the present disclosure provides a system for performing illumination-aware rendering based on real-world shadow analysis. The system includes one or more processors and a memory communicatively coupled to the one or more processors. The memory stores instructions that, when executed by the one or more processors, cause the system to receive, using a receiving module, one or more images of a physical environment captured by one or more sensors of a user device. The one or more processors, using an analysis module, analyze the one or more images to derive one or more features representative of lighting, texture, and spatial composition. The one or more processors, using a classification module, classify the image into at least one of a first shadow-type scene or a second shadow-type scene. The one or more processors, using a generation module, generate one or more illumination parameters based on the classification of the shadow-type scene. The one or more illumination parameters define at least a direction, intensity, and diffusion of one or more light sources. The one or more processors, using a positioning module, place, in a three-dimensional rendering environment, one or more light sources derived from the one or more illumination parameters. The one or more processors, using a rendering module, render, in the three-dimensional rendering environment, at least one digital object spatially aligned with the physical environment using positional coordinates obtained from the image. The one or more processors, using a casting module, cast one or more shadows of the at least one digital object within the rendered scene based on the one or more illumination parameters. The one or more processors, using a compositing module, composite the rendered scene with the image of the physical environment to generate an augmented image. The augmented image includes the at least one digital object and the one or more shadows.

In an embodiment of the present disclosure, the first shadow-type scene corresponds to directional illumination producing hard shadows, and the second shadow-type scene corresponds to diffused illumination producing soft shadows.

In an embodiment of the present disclosure, the classification of the shadow-type scene is based on at least one of luminance contrast, edge sharpness, or gradient entropy.

In an embodiment of the present disclosure, the one or more illumination parameters include at least one of a light direction vector, a diffusion coefficient, a brightness ratio, or a color temperature value.

In an embodiment of the present disclosure, the generation of the one or more illumination parameters includes performing geometric correlation between shadow boundaries and corresponding light vectors derived from a depth map.

In an embodiment of the present disclosure, the placement of the one or more light sources includes assigning spatial coordinates in the three-dimensional rendering environment. The assignment is done based on the one or more illumination parameters and a physical orientation of the user device.

In an embodiment of the present disclosure, the rendering of the at least one digital object includes applying material-aware shading and reflection properties based on the one or more illumination parameters.

In an embodiment of the present disclosure, the casting of the one or more shadows includes simulating self-shadows and ground shadows of the at least one digital object using the classified illumination type.

In an embodiment of the present disclosure, the compositing of the rendered three-dimensional environment with the image of the physical environment includes blending pixel values using alpha masking and tone-mapped color alignment.

In an embodiment of the present disclosure, the system dynamically updates the one or more illumination parameters and re-renders the augmented image in response to real-time lighting changes detected through the one or more sensors.

In another aspect, the present disclosure provides a method for performing illumination-aware rendering based on real-world shadow analysis. The method includes receiving one or more images of a physical environment captured by one or more sensors of a user device. The method includes analyzing the one or more images to derive one or more features representative of lighting, texture, and spatial composition. The method includes classifying the image into at least one of a first shadow-type scene or a second shadow-type scene. The method includes generating one or more illumination parameters based on the classification of the shadow-type scene. The one or more illumination parameters define at least a direction, intensity, and diffusion of one or more light sources. The method includes placing, in a three-dimensional rendering environment, one or more light sources derived from the one or more illumination parameters. The method includes rendering, in the three-dimensional rendering environment, at least one digital object spatially aligned with the physical environment using positional coordinates obtained from the image. The method includes casting one or more shadows of the at least one digital object within the three-dimensional rendering environment based on the one or more illumination parameters. The method includes compositing the rendered three-dimensional environment with the image of the physical environment to generate an augmented image. The augmented image includes the at least one digital object and the one or more shadows.

In yet another aspect of the present disclosure, a non-transitory computer-readable medium is disclosed. The non-transitory computer-readable medium stores instructions that, when executed by one or more processors, cause a system to perform a method for performing illumination-aware rendering based on real-world shadow analysis. The method includes classifying the image into at least one of a first shadow-type scene or a second shadow-type scene. The method includes generating one or more illumination parameters based on the classification of the shadow-type scene. The one or more illumination parameters define at least a direction, intensity, and diffusion of one or more light sources. The method includes placing, in a three-dimensional rendering environment, one or more light sources derived from the one or more illumination parameters. The method includes rendering, in the three-dimensional rendering environment, at least one digital object spatially aligned with the physical environment using positional coordinates obtained from the image. The method includes casting one or more shadows of the at least one digital object within the three-dimensional rendering environment based on the one or more illumination parameters. The method includes compositing the rendered three-dimensional environment with the image of the physical environment to generate an augmented image. The augmented image includes the at least one digital object and the one or more shadows.

### BRIEF DESCRIPTION OF DRAWINGS

Having thus described the disclosure in general terms, references will now be made to the accompanying figures, wherein:

FIG. 1 illustrates a schematic representation of an exemplary computing environment configured for dynamic shadow casting in a mixed-reality environment, in accordance with various embodiments of the present disclosure;

FIG. 2 illustrates a block diagram of a system depicting internal modules configured for generating illumination-consistent virtual shadows in real time, in accordance with various embodiments of the present disclosure;

FIG. 3 illustrates a flowchart of a method for performing the dynamic shadow casting in the mixed-reality environment, in accordance with various embodiments of the present disclosure; and

FIG. 4 illustrates a block diagram of an exemplary device, in accordance with various embodiments of the present disclosure.

It should be noted that the accompanying figures are intended to present illustrations of exemplary embodiments of the present disclosure. The figures are not intended to limit the scope of the present disclosure. It should be noted that accompanying figures are not necessarily drawn to scale.

### DETAILED DESCRIPTION

Some embodiments of the disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described. Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

While the present invention is described herein by way of example using embodiments, those skilled in the art will recognize that the invention is not limited to the embodiments described and are not intended to represent the scale of the various components. It should be understood that the detailed description thereto is not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers, or steps. Likewise, the term “comprising” is considered synonymous with the terms “including” or “containing” for applicable legal purposes. Any discussion of documents, acts, materials, devices, articles, and the like is included in the specification solely for the purpose of providing a context for the present invention. It is not suggested or represented that any or all of these matters form part of the prior art base or were common general knowledge in the field relevant to the present invention.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. The values and ranges are to be treated as examples only, and are not intended to limit the scope of the claims. In addition, a number of system architectures are identified as suitable for various facets of the implementations. The system architectures are to be treated as exemplary and are not intended to limit the scope of the invention.

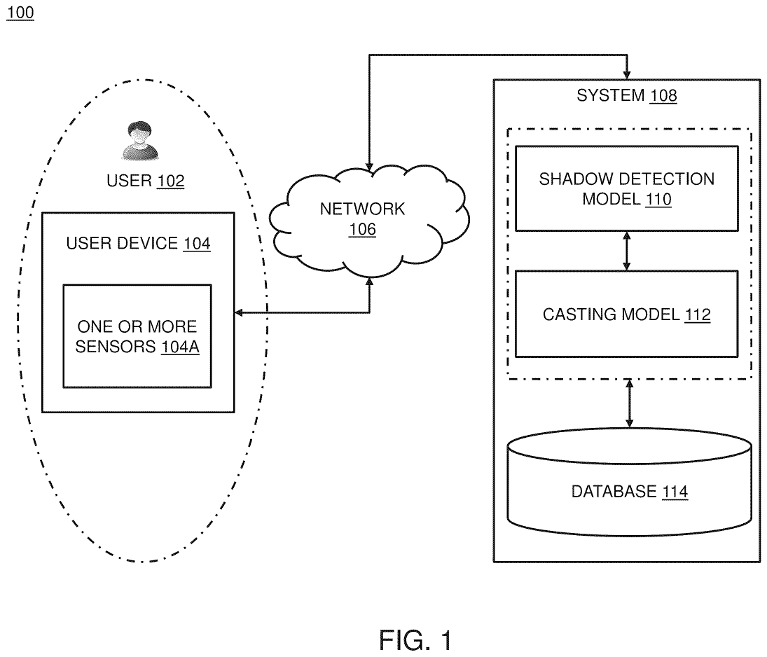

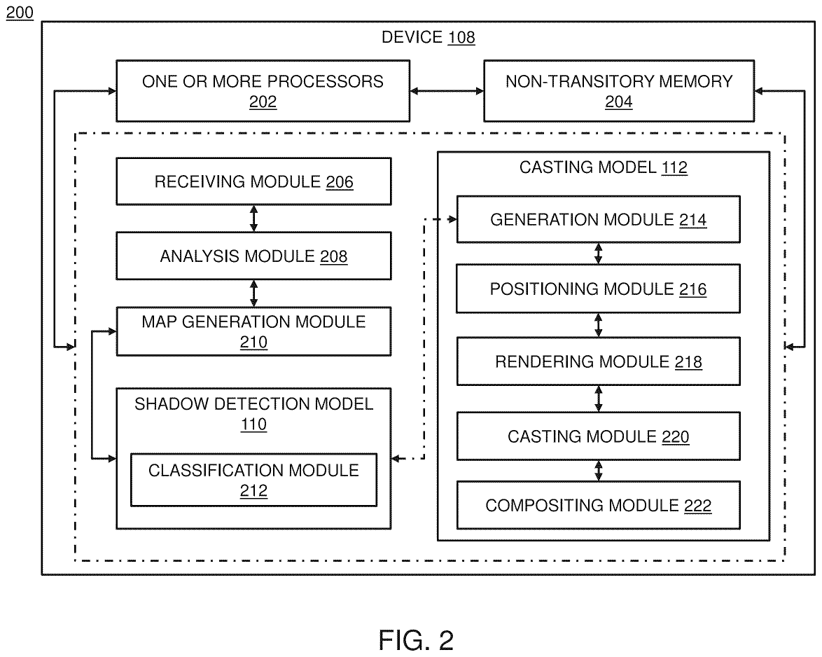

FIG. 1 illustrates a schematic representation of an exemplary computing environment 100 configured for dynamic shadow casting in a mixed-reality (MR) environment, in accordance with various embodiments of the present disclosure. The computing environment 100 represents a distributed, hybrid cloud-edge architecture designed to detect, analyze, and project illumination-consistent shadows within a physical scene in real time. The computing environment 100 functions as an intelligent photometric-simulation ecosystem that observes real-world lighting behavior, interprets geometric and photometric parameters, and synthesizes corresponding virtual light interactions for digital content perceived by a user 102.

The computing environment 100 includes a user device 104 equipped with one or more sensors 104A, a network 106, and a system 108. The system 108 executes the shadow-detection model 110 and the casting model 112. The components interact cooperatively to capture visual and spatial data, interpret lighting cues, and synthesize illumination-aligned digital shadows accurately corresponding to the real-world lighting observed around the user 102.

In operation, the environment 100 fuses sensing, analysis, and rendering pipelines into a continuous feedback loop, thereby maintaining temporal stability, spatial alignment, and photometric coherence between physical and digital entities even under dynamically changing illumination. The architecture is modular and scalable, supporting both single-user and multi-user MR sessions in which each participant experiences consistent light-source orientation and shadow geometry.

The computing environment 100 provides an integrated computational framework that observes real-world lighting, interprets photometric parameters, and synchronizes corresponding virtual-shadow behavior across digital content displayed to the user 102. The environment 100 supports both on-device and distributed execution, enabling real-time inference through cooperation between local sensors and cloud-based AI models.

The computing environment 100 achieves illumination fidelity between real and virtual entities by capturing illumination through sensors 104A, deriving contextual light-behavior features via a shadow-detection model 110, and activating a casting model 112 to generate light-projection data aligning digital objects with the detected physical lighting direction. A database 114 stores reference illumination parameters, trained model weights, and historical scene descriptors for adaptive refinement of both detection and casting. Collectively, these elements ensure that mixed-reality scenes maintain natural visual coherence even when ambient light fluctuates.

In the context of the present disclosure, the shadow casting refers to a computational process of simulating how real-world light interacts with virtual or physical objects to produce occluded regions that exhibit realistic shading, intensity, and geometry. From a physical perspective, shadow casting determines where incident light rays are blocked by an object; from a computational perspective, it calculates those occlusions and projects them into the mixed-reality rendering space.

Casting encompasses both self-shadows, regions of the object that obscure themselves from light and ground-shadows, which are cast by the object onto surrounding real surfaces. For example, a virtual coffee mug placed on a real desk produces a self-shadow inside a handle part of the coffee mug and a ground-shadow extending on the desk. In another example, a digital character standing under a lamp in an AR scene casts a soft shadow on the floor and subtle self-shading on torso of the digital character, synchronized with the lamp's detected brightness and direction.

The physical environment denotes any real-world space surrounding a user, including outdoor settings such as streets, parks, and plazas, and indoor settings such as homes, studios, industrial facilities, or public venues. The environment contains natural and artificial light sources, for example, sunlight, skylight, lamps, LEDs, fluorescent fittings, and light reflected from nearby surfaces, each of which produces characteristic shadow behavior. Further, the environment 100 contains physical objects that occlude light and form shadows, including static structures (walls, floors, furniture) and dynamic entities (people, vehicles, foliage). Surface properties such as texture, reflectivity, albedo, and material composition materially influence shadow appearance: a polished marble floor yields low-contrast, specular highlights and softer apparent penumbras, whereas a rough matte concrete surface produces higher-contrast, sharper shadow edges. The interactive computing environment continuously observes these variations, including time-of-day changes, weather shifts, and user or object motion, so captured imagery and derived illumination descriptors remain contextually valid for shadow detection, SDRR map construction, and subsequent photometric alignment used for realistic shadow casting.

Also, the physical environment includes spatial and contextual metadata that the system 108 leverages to refine its illumination interpretation. Such metadata may include geographic coordinates, orientation/pose, timestamps, and coarse environmental cues (for example presence/absence of a ceiling or sky). System 108 uses this metadata to infer likely illumination states (for example sun azimuth and elevation for a given time and location) and to adapt processing strategies: outdoors, system 108 places greater emphasis on estimating directional light vectors (useful for hard-shadow synthesis); indoors, system 108 gives higher weight to HDRI-style ambient field estimation and multi-source mapping (useful for soft-shadow and global-illumination approximation). This contextual awareness helps the classification logic select an appropriate estimation and rendering pipeline, for instance choosing ray-projection from a 3D object when direct directional lighting dominates, or selecting environment-map relighting when diffuse ambient lighting prevails.

The system 108 recognises that real environments often contain multiple concurrent light sources and complex inter-reflections. Accordingly, the environment 100 representation explicitly models dominant versus ambient sources and tags observed lighting conditions as hard (dominated by a single, directional source) or soft (dominated by multiple, diffuse sources). The system 108 records the transient illumination events such as flicker from the artificial fixtures or occlusions caused by passing vehicles or moving people. The system 108 processes the observed lighting data through several internal modules. The modules include a temporal-smoothing module, a confidence-evaluation module, and a decision module. Each module analyzes the consistency of illumination patterns and the reliability of detected shadow parameters. Based on the analysis, the decision module determines whether to immediately reclassify the scene and update the shadow-casting parameters. In other cases, the decision module may collect and average data over a short temporal buffer to achieve a more stable lighting estimate. Alternatively, when major changes in illumination are detected, the system 108 may trigger harmonization and re-rendering to ensure the projected shadows remain visually consistent with the real-world environment

For example, when a single bright sunbeam creates crisp cast shadows, system 108 selects a directional-light, 3D-model based casting pipeline (to generate both ground-and self-shadows); when cloud cover produces uniform skylight, system 108 selects an HDRI-probe relighting pipeline that emphasizes soft, low-contrast shadows.

The user 102 interacts with the MR experience through the user device 104, which may be a smartphone, tablet, or head-mounted display. Multiple users (102A, 102B, 102C . . . ) can simultaneously participate in a shared environment, each perceiving identical shadow behavior in real time. The system 108 synchronizes their illumination contexts through the network 106, ensuring cross-device coherence.

The user 102 represents an individual who interacts with the system 108 through the user device 104 to experience real-time illumination analysis and mixed-reality rendering. The user 102 may initiate or join a session either explicitly or automatically. Explicit initiation may occur when the user launches an application, selects an activation link, or scans a spatial marker that triggers the illumination-analysis or shadow-casting workflow. Automatic initiation may occur through contextual triggers such as geolocation events, object recognition, or detected changes in ambient lighting captured by the one or more sensors 104A. Once activated, the user device 104 begins continuous acquisition of images and sensor data representing the physical environment. The system 108 processes these data streams to determine shadow presence, light-source orientation, diffusion characteristics, and SDRR-map parameters that together define the prevailing illumination state for accurate rendering of both physical and digital shadows.

The user device 104 acts as the primary interface and data-capture component within the environment 100. It includes one or more processors, memory units, communication interfaces, and sensors configured to collect imagery and environmental data. Exemplary embodiments of the user device 104 include smartphones, tablets, laptops, augmented-reality (AR) headsets, smart glasses, or other wearable computing systems capable of capturing high-resolution frames of the physical scene. The user device 104 may execute localized pre-processing such as frame normalization, color-space correction, noise filtering, or feature encoding to reduce transmission load and latency. In some configurations, the user device 104 performs partial inference using a compact on-device model, for example, computing a low-resolution SDRR map or a preliminary shadow probability mask, and transmits compact descriptors to the system 108 for full-scale refinement and global consistency alignment.

The user device 104 operates simultaneously as a capture instrument and a display platform. The user device 104 renders visual content enhanced by illumination descriptors received from the system 108, ensuring that projected shadows, highlights, and reflections appear photometrically consistent with real-world lighting. For instance, when a virtual 3D object is anchored onto a physical surface in the user's field of view, the casting model 112 ensures that the shadow's direction, edge softness, and luminance correspond precisely to the lighting parameters computed from the captured environment. To the user 102, the result appears as a seamless, natural blend between real and virtual elements. In a multi-user session, each user device 104 receives synchronized shadow projections so that all participants perceive identical spatial and photometric outcomes in their respective viewpoints.

The one or more sensors 104A integrated within the user device 104 capture multimodal data streams describing the surrounding physical environment. The one or more sensors 104A may include an RGB or multispectral camera for color imagery, and a depth or LiDAR sensor for spatial-distance estimation. In addition, the one or more sensors 104A may include an inertial measurement unit (IMU) for motion and orientation tracking, and one or more photometric sensors for measuring ambient luminance and color temperature. Optional auxiliary sensors, such as proximity, thermal, or infrared detectors, enhance contextual awareness. The one or more sensors 104A operate synchronously to generate a time-aligned dataset that encodes both visual and spatial characteristics of the scene. The synchronization enables alignment of each color frame precisely with corresponding depth and illumination readings.

In an embodiment, the one or more sensors 104A record metadata for each captured frame. The metadata may include camera orientation, focal length, aperture, exposure time, white-balance coefficients, and device pose relative to world coordinates. The system 108 uses the metadata to reconstruct the camera viewpoint and to compensate for optical or positional variations across devices. For example, if two users capture the same physical object under identical lighting but with different devices, the system 108 employs calibration data to normalize focal distortions and exposure differences before performing global illumination analysis. IMU readings are fused with image data to stabilize perceived geometry as the user 102 moves, and maintains temporal coherence of the detected and projected shadows. The fusion allows the system 108 to predict motion-induced illumination changes and to update shadow geometry accordingly in real time.

The network 106 connects the user device 104 and the system 108, supporting bidirectional exchange of captured data, intermediate inference results, and illumination-casting outputs. The network 106 may include wired or wireless channels such as 4G, 5G, Wi-Fi 6, or next-generation optical and satellite links, and may operate across Internet, intranet, or hybrid cloud-edge configurations. The network ensures sufficient bandwidth and low latency for continuous illumination analysis and dynamic shadow rendering.

In certain embodiments, the network 106 incorporates edge-computing nodes positioned close to the user device 104 to execute preliminary pre-processing before transmitting data to the central system 108. The nodes may perform exposure normalization, feature filtering, or partial SDRR inference to reduce computational load on the cloud and minimize latency. The network 106 supports hybrid inference operation, wherein on-device or edge models deliver immediate frame-level illumination updates for responsiveness, while cloud-based models aggregate sequences of frames for high-precision photometric refinement.

The system 108 represents a distributed computing framework configured for analyzing illumination conditions, detecting shadow regions, and casting photometrically consistent shadows for digital and physical entities within a mixed-reality environment. The system 108 may be implemented as a cloud-based architecture, an edge computing platform, or a hybrid configuration that dynamically delegates processing tasks between local and remote nodes based on latency, bandwidth, and device capabilities. The system 108 includes one or more processors, memory modules, graphical computation units (GPUs), and artificial-intelligence accelerators such as tensor cores or neural processing units (NPUs).

In operation, the system 108 establishes a closed feedback loop between environmental sensing, model-driven inference, and mixed-reality rendering. The one or more processors execute a modular processing pipeline that includes data acquisition, feature analysis, shadow detection, light estimation, shadow casting, and rendering feedback. Each stage in the pipeline is temporally aligned and logically coupled so that illumination updates propagate consistently through the network 106 and across all connected user devices 104. The architecture supports concurrent multi-session execution, where multiple users may share or interact within the same physical or virtual space and perceive identical shadow behavior in real time.

The shadow detection model 110 functions as the analytical foundation for identifying shadow regions within the captured imagery. The shadow detection model 110 receives as input a set of calibrated images, depth maps, and contextual sensor metadata acquired from the user device 104. The shadow detection model 110 performs pixel-level segmentation to delineate regions of occlusion or reduced illumination, producing one or more shadow masks that encode the likelihood of shadow presence for each pixel. The shadow detection model 110 leverages a multi-branch neural architecture integrating convolutional backbones for local feature extraction and transformer layers for global context aggregation.

In an embodiment, the shadow detection model 110 operates on SDRR (Shadow Directional Reflection and Relighting) maps generated from the input imagery. An SDRR map is a structured representation encoding per-pixel light direction vectors, local reflection intensities, and ambient-diffusion coefficients. The shadow detection model 110 analyses the SDRR map and determines the shadow geometry, depth offset, and edge gradients of occluded regions. Accordingly, the system 108 reconstructs how light interacts with surrounding materials and to determine whether the observed shadows are self-shadows or ground shadows. Self-shadows are the shadows projected onto the same object surface. Ground shadows are shadows which are cast onto other surfaces such as floors, walls, or nearby objects.

The shadow detection model 110 is trained using a hybrid dataset. The hybrid dataset includes real-world annotated images and synthetically generated illumination scenarios created via physically based rendering (PBR). The training process optimizes multi-objective loss functions that combine segmentation accuracy, edge sharpness, and depth consistency. The shadow detection model 110 may include a confidence-estimation subnetwork that quantifies reliability of shadow predictions based on photometric variance and temporal stability. These confidence values are used downstream to determine whether the detected shadows are robust enough to drive projection and rendering or require re-analysis using fallback heuristics.

The casting model 112 receives as input, the illumination descriptors, shadow masks, and the SDRR parameters generated by the shadow detection model 110. The casting model 112 synthesizes and projects' digital shadows that align with both the physical and virtual light sources observed in the real-world scene. The casting model 112 employs a combination of AI-based light-field reconstruction algorithms and physics-based rendering techniques to estimate how light rays originating from detected sources interact with virtual 3D geometries. In addition, the casting model 112 computes a light-projection matrix that includes directional vectors, light intensity coefficients, diffusion factors, and color-temperature mappings.

In an embodiment of the present disclosure, the casting model 112 utilizes a 3D model of each virtual object to simulate light interaction accurately. The 3D model includes information on surface normals, material reflectivity, and spatial boundaries. Using the SDRR map as a contextual illumination reference, the casting model 112 computes ray intersections between light vectors and object surfaces to determine the geometry of self-shadows and ground shadows. Self-shadows are the darker regions that appear on a side of a virtual object facing away from the light source. Ground shadows are the projections cast onto other surfaces within the physical environment. For example, when a virtual chair is rendered on a real-world floor under daylight, the casting model 112 computes the correct angle and softness of the chair's ground shadow using the directional light vector extracted from the SDRR map.

The casting model 112 supports both AI-driven and non-AI rendering pipelines. In the AI-driven approach, deep neural networks such as conditional generative adversarial networks (cGANs) or diffusion-based relighting models learn to predict shadow intensity fields conditioned on environmental inputs. In the non-AI approach, deterministic algorithms perform geometric projection based on ray tracing and vector transformations. The casting model 112 may dynamically select between the pipelines depending on device capabilities and required rendering speed.

The shadow detection model 110 and casting model 112 are functionally interlinked. The detection model 110 provides illumination-aware segmentation, and the casting model 112 consumes the segmentation results to render physically coherent shadows. A feedback loop between the two models allows the casting output to inform further refinement of detection thresholds and light-vector calibration. For instance, when a rendered shadow appears photometrically inconsistent with the observed lighting, the system 108 automatically re-evaluates the SDRR map and updates the detection model's input parameters.

In an embodiment, the casting model 112 integrates multi-user and multi-device synchronization capabilities. The system 108 maintains a shared illumination state distributed across all connected devices 104 through the network 106. The shared state ensures that when one user interacts with or repositions a digital object, the corresponding shadows update consistently for all other users viewing the same scene. The system 108 achieves synchronization through timestamp alignment using network time protocol (NTP) and differential shadow compression, which transmits only incremental updates in lighting parameters to conserve bandwidth.

The output of the casting model 112 includes the final shadow maps, the illumination descriptors, and geometric projection data. The output specifies parameters such as shadow vector fields, brightness coefficients, and reflection indices, which are transmitted to the user device 104 for integration into the rendering pipeline. When displayed to the user 102, the rendered scene exhibits consistent spatial alignment and visual realism, with digital shadows blending seamlessly with the real-world objects. For example, a user observing a virtual sculpture under an indoor lamp perceives both the physical and digital shadows converging naturally, preserving depth cues and spatial context.

In an embodiment, the system 108 extends the rendering logic to multi-object and dynamic-scene scenarios, where multiple virtual and real entities coexist. The system 108 assigns independent shadow streams per object, aggregates overlapping light contributions, and applies shadow compositing techniques to maintain visual plausibility. In collaborative environments, such as architectural design sessions or interactive training, users perceive identical shadow geometries regardless of a vantage point.

The database 114 represents a structured data repository that stores illumination-related information, model parameters, and historical scene descriptors. The database 114 may be implemented as a distributed data-management architecture that supports both local caching on user devices and centralized synchronization across cloud or edge servers through the network 106. In addition, the database 114 stores multiple categories of data. The categories include illumination datasets, model weights and training artifacts, device calibration data such as lens profiles and sensor parameters, and temporal lighting logs. Also, the database 114 records contextual metadata such as location tags, timestamps, and scene classifications (for example, indoor/outdoor, hard/soft illumination, single/multiple light sources). The database 114 communicates bi-directionally with the shadow detection model 110 and the casting model 112. The database 114 supplies model weights, calibration data, and training samples to the models.

While FIG. 1 illustrates a single user 102 interacting with a single user device 104, multiple users may simultaneously engage with respective devices operating in separate or shared environments. Each user device executes illumination analysis and rendering operations and may transmit contextual information such as illumination parameters, light-source vectors, or environmental descriptors to the system 108 over the network 106.

The number and arrangement of systems, devices, and networks depicted in FIG. 1 are illustrative and not restrictive. Additional or alternative computational nodes, sensors, or visualization modules may be incorporated based on deployment requirements. In certain embodiments, all illumination processing and rendering may occur locally on the user device 104, while in others, distributed configurations utilize edge servers or cloud platforms for large-scale illumination refinement and synchronization. Such architectural scalability allows the computing environment 100 to operate seamlessly across smartphones, AR headsets, and collaborative MR platforms with consistent performance and lighting realism.

Beyond these configurations, the system 108 is configured to execute harmonization pipelines that combine sensor fusion data streams with illumination parameter models. In one embodiment, RGB imagery, depth sensor input, and photometric data are integrated to compute pixel-level illumination parameters, enabling precise alignment of rendered virtual shadows, highlights, and reflections with real-world lighting. The fusion process ensures that digital objects maintain natural coherence with physical lighting dynamics, producing perceptually seamless augmented and mixed reality scenes.

FIG. 2 illustrates a block diagram 200 of the system 108 for detecting and classifying the shadows in the physical environment in real time, in accordance with various embodiments of the present disclosure. The figure shows the internal system modules and the data flow relationships that collectively enable the system 108 to receive image data, generate depth information, detect shadow regions, classify lighting conditions, and output illumination-related parameters.

The system 108 includes one or more processors 202 operatively coupled to a non-transitory memory 204. The non-transitory memory 204 stores executable instructions that, when executed by the one or more processors 202, cause the system 108 to perform real-time image analysis and environmental lighting interpretation. The one or more processors 202 execute these program instructions to process image data captured by the one or more sensors 104A of the user device 104. The processors analyse the incoming frames, generate shadow masks, classify scenes into pre-defined shadow types, and estimate directional illumination cues. References to the elements of FIG. 1 are made throughout this section for clarity and coherence.

The system 108 includes a modular processing pipeline executed by the one or more processors 202. The pipeline consists of a sequence of specialized modules designed to process environmental data in a logically ordered and feedback-driven manner. The modules include a receiving module 206, an analysis module 208, a generation module 210, a detection module 212a, a mask generation module 212b, and a classification module 212c. In addition, the modules include a geometry generator module 216, an estimation module 214, a score calculation module 218 and an output module 220. The above-mentioned modules are exemplary and non-limiting. In certain implementations, additional or alternative modules may be incorporated within the system 108 to accommodate diverse deployment scenarios or environmental complexities.

The plurality of system modules are operatively coupled in a structured workflow that enables continuous data flow and adaptive feedback between modules. Each module produces outputs that serve as standardized inputs for subsequent modules, maintaining a consistent data representation throughout the analysis pipeline. The interconnection of modules ensures that the shadow detection and classification process proceeds sequentially, from image acquisition to illumination estimation. The module interaction allows real-time re-evaluation when environmental lighting changes are detected.

The elements of the system 108 described herein are operatively coupled to enable end-to-end environmental analysis for illumination understanding. The one or more processors 202 orchestrate the operation of these modules by executing program instructions stored in the non-transitory memory 204. The execution flow begins with reception of image and sensor data from the user device 104 and proceeds through depth estimation, shadow detection, classification, and light parameter generation. Each module operates either independently or cooperatively with adjacent modules depending on runtime conditions, resource availability, and environmental complexity.

The memory 204 stores instructions that enable dynamic, adaptive analysis of the lighting conditions in real time. The processors 202 are operably coupled with the receiving module 206, the analysis module 208 and the generation module 210. Also, the one or more processors 202 are operably coupled to the detection module 212a, a mask generation module 212b, and a classification module 212c. In addition, the one or more processors are operably coupled to the geometry generator module 216, the estimation module 214, the score calculation module 218 and the output module 220. The modules collectively operate to maintain a low-latency analytical pipeline optimized for continuous operation.

The components of the system 108 operate in synchronization to enable the user 102 to experience a contextually accurate visualization or analytical output that reflects the actual lighting conditions of the environment. The system 108 functions within a distributed computing environment that includes the user device 104, one or more edge servers hosting the shadow detection model 110, and the cloud database 112. The distributed configuration allows real-time updates to model parameters and ensures consistency of shadow interpretation across multiple devices.

The non-transitory memory 204 stores instructions that, when executed, cause the processors 202 to perform the complete analytical cycle, from triggering image acquisition to producing the illumination-classification outputs. The output data includes shadow masks, light-source direction, illumination intensity, and confidence metrics. These parameters enable accurate reconstruction of scene lighting and serve as critical inputs for any downstream rendering or augmented visualization tasks.

Each module of the system 108 is designed to be independently deployable and replaceable without disrupting the overall operation. The modular structure provides extensibility and adaptability to future system updates, sensor enhancements, or advanced model versions. The system 108 functions as a scalable and reconfigurable analytical platform capable of supporting diverse lighting-analysis requirements in real-world environments.

The receiving module 206 is configured to receive one or more images and sensor data representing the physical environment. The term receiving module, as used herein, refers to a system component that ingests multimodal data streams, including visual, spatial, and photometric inputs, from the user device 104 or other connected imaging sources.

In an embodiment, the receiving module 206 obtains the environmental images captured by the one or more sensors 104A embedded in the user device 104. The one or more sensors 104A may include an RGB or multispectral camera, a LiDAR sensor, an ambient-light sensor, or an inertial measurement unit (IMU). The receiving module 206 retrieves image frames, depth readings, and associated metadata such as exposure settings, timestamp, and device pose.

The receiving module 206 performs pre-processing operations such as format conversion, color-space normalization, and resolution adjustment. The receiving module 206 may convert incoming frames into a linear color representation to maintain accurate luminance values for identifying light intensity gradients and shadow regions.

In another embodiment, the receiving module 206 implements data validation and synchronization logic. The synchronization aligns the incoming data streams, such as image, depth, and IMU readings by matching timestamps and compensating for latency offsets. In distributed configurations, the receiving module 206 may interface with edge nodes that locally cache incoming frames before forwarding to cloud servers for inference.

The analysis module 208 analyzes the received image and the sensor data to extract representative features. The features describe illumination characteristics, texture gradients, and spatial composition of the physical environment. In an embodiment, the analysis module 208 performs pixel-level computations. The pixel-level computations may include gradient estimation, edge detection, and color-segmentation analysis. The analysis module 208 isolates contrast variations corresponding to shadow boundaries and calculates chromaticity-invariant features that differentiate real shadows from dark materials.

The map generation module 210 generates structured spatial representations of the physical environment based on the output of the analysis module 208. The module produces a depth map that defines a relative distance between the user device 104 and objects within the scene. The depth map enables the system 108 to infer spatial geometry relevant to shadow formation and projection. In an embodiment, the map generation module 210 may employ depth-estimation techniques such as stereo disparity computation, monocular depth inference, or LiDAR fusion. The map generation module 210 refines the estimated depth using illumination gradients from the analysis module 208. The refined depth representation is processed into a geometric model that captures both occluders and receiving surfaces essential for shadow casting. The map generation module 210 outputs an environmental map object containing depth, surface-normal, and illumination-gradient data.

The shadow detection model 110 and the casting model 112 constitute an artificial-intelligence inference core of the system 108. The shadow detection model 110 is configured to detect and delineate the one or more shadow regions within the image of the physical environment in real time. The shadow detection model 110 implements a hybrid architecture that combines multi-scale convolutional feature extraction with transformer-based global-context reasoning. The shadow detection model 110 receives the processed image and depth data from the map-generation module 210 and the analysis module 208 stages. Accordingly, the shadow detection model 110 outputs a probability distribution representing the likelihood of shadow presence for every pixel in the scene.

In an embodiment, the shadow detection model 110 employs an encoder-decoder configuration with a feature-pyramid backbone and attention-based contextual modeling. The encoder extracts hierarchical spatial features using residual and dilated convolutional layers. The decoder reconstructs pixel-level detail through skip connections. The integrated transformer mechanism applies multi-head self-attention to model long-range relationships across the frame. The relationships allow the shadow detection model 110 to distinguish between illumination changes arising from physical occlusion and those caused by material color or reflectance variation.

The shadow detection model 110 is trained on a composite dataset. The composite dataset includes real-world and synthetically rendered images annotated at the pixel level. The synthetic subset provides controlled lighting scenarios, and the real-world subset contributes environmental variability such as diffused skylight, artificial lamps, and partial occlusions. The training process optimizes a composite loss function that balances segmentation accuracy, edge preservation, and depth consistency.

The shadow detection model 110 performs an initial detection operation that localizes one or more probable shadow regions within the received image and the associated depth data. The shadow detection model 110 analyzes luminance gradients, depth discontinuities, and chromatic uniformity to differentiate genuine light-occlusion areas from surface texture variations. The output of the operation is a preliminary shadow-likelihood map that marks potential shadow regions with corresponding confidence values.

During inference, the shadow detection model 110 applies normalization to align live-frame distributions with training statistics and executes multi-scale analysis to capture coarse and fine shadow structures. Lower-resolution analysis identifies large, soft illumination regions, and higher-resolution passes preserve the edges of sharply defined shadows. The results enable the generation of the unified probability map that adapts effectively to diverse lighting conditions.

In another embodiment, the detection process incorporates adaptive thresholding and temporal stabilization to maintain accuracy in continuous video streams. The adaptive thresholding dynamically adjusts to scene brightness and contrast. The temporal filtering ensures that transient lighting changes do not cause perceptual flicker. The resulting probability map represents a stable, geometry-aligned basis for precise segmentation refinement in subsequent processing.

The shadow detection model 110 performs mask-generation operations to transform the probabilistic shadow map into a refined, high-precision segmentation. The operation converts continuous likelihood values into a binary or confidence-weighted shadow mask that delineates the exact spatial extent of each shadow. The refinement process includes morphological filtering to remove isolated artifacts and depth-constrained boundary alignment. The detection process ensures that the shadow edges correspond to real surface transitions in the environment.

In an embodiment, the shadow detection model 110 integrates geometric and photometric cues to refine the shadow contours. Confidence-weighted smoothing combines reliability scores from earlier layers with gradient-guided filtering. The shadow detection model 110 adjusts boundary characteristics in accordance with the detected illumination type. The shadow detection model 110 applies crisp, narrow edges for the hard shadows and soft feathering profiles for the diffused lighting conditions. The mask-generation process provides a geometrically consistent, photometrically stable, and temporally coherent shadow mask aligned with the physical scene geometry. The refined representation forms the foundation for subsequent illumination estimation and casting processes.

The classification module 212 of the shadow detection model 110 classifies the image into at least one of the first shadow type scene or the second shadow type scene. The classification module 212 classifies the detected shadow regions into one or more shadow types based on luminance, softness, and edge gradients. In an embodiment, the classification module 212 assigns each detected shadow to categories such as hard shadow, soft shadow, or self-shadow. The term hard shadow refers to a sharply defined region created by a direct light source, and soft shadow indicates a diffused boundary produced by scattered illumination.

The classification module 212 operates as an interpretive and analytical component that determines the prevailing lighting condition in the physical environment based on the detected and refined shadow information. The first shadow-type scene represents the directional illumination characterized by hard, sharply bounded shadows produced under concentrated light sources, such as direct sunlight or spot lighting. The second shadow-type scene corresponds to diffused or ambient illumination, where shadows appear soft, faint, or non-distinct due to scattered or multi-source lighting.

In an embodiment of the present disclosure, the classification module 212 receives the refined shadow masks and the associated confidence maps. The classification module 212 computes multiple statistical and geometric descriptors that represent the spatial and the photometric characteristics of the detected shadows. The descriptors include a ratio of shadow area to illuminated area, a mean luminance contrast between shadowed and non-shadowed pixels, the edge sharpness gradient, and the angular coherence of light direction across the scene. The classification module 212 integrates convolutional neural features and deterministic analytical features to evaluate the descriptors. The convolutional features capture texture continuity and global lighting uniformity. The analytical functions quantify local intensity transitions and chromatic constancy across shadow boundaries.

The classification module 212 analyzes aggregated region descriptors, such as centroid location, principal axis orientation, and local depth variance, to infer the dominant light-source behavior. The aggregated descriptors are combined into feature vectors representing the global illumination characteristics of the environment. In an embodiment, the classification module may employ a compact attention-based network layer to process the feature vectors. The network layer assigns higher weight to shadow regions that exhibit coherent directional orientation or consistent luminance falloff. The selective weighting ensures that the classification result emphasizes on the physically dominant light contributions. Also, the network layer minimizes influence of transient or secondary reflections.

In another embodiment, the classification module 212 employs geometric correlation between the shadowed and illuminated regions to reinforce classification confidence. In an embodiment, shallow depth variation combined with abrupt luminance transitions indicates a hard shadow (the first shadow type). In an embodiment, gradual intensity falloff with larger depth variation suggests soft, diffused illumination (the second shadow type).

In an embodiment, the classification module 212 evaluates contextual cues such as lighting color temperature, global luminance variance, and angular shadow dispersion. The contextual cues are evaluated to infer whether the scene corresponds to indoor or outdoor illumination. Typically, warmer color temperatures with multiple intersecting shadows denote artificial indoor light, and cooler tones with unidirectional shadow alignment correspond to sunlight. Based on the contextual cues, the system 108 selects the appropriate illumination estimation strategy. The estimation strategy may include either a single-vector directional computation for the outdoor scenes or an HDRI-probe-based estimation for the indoor scenes.

For instance, when analyzing a living room illuminated by sunlight entering through a window and supplemented by a ceiling lamp, the classification module 212 identifies two distinct illumination patterns. The classification module 212 classifies the sunlight as the first shadow-type (hard, directional) and the ceiling lamp as the second shadow-type (soft, diffused), generating the composite illumination label.

The shadow detection model 110 estimates the direction and intensity of one or more light sources present in the physical environment based on the depth information. The shadow detection model 110 processes pre-normalized image and the depth data to identify the shadowed and the illuminated regions and estimate occluders. Also, the shadow detection model 110 derives the spatial relationships between the shadowed and the illuminated regions. The system 108 utilizes the cues to distinguish between the hard shadows and the soft shadows.

The shadow detection model 110 constructs a partial three-dimensional representation of the scene from the depth data and the shadow data. The system 108 refines the reconstruction by aligning the detected shadow boundaries with surface-depth discontinuities, identifying occluders and receivers, and estimating surface normals for each region. In multi-view scenarios, such as when a user moves around the environment, the system 108 fuses multiple viewpoints using spatial-alignment algorithms to maintain geometric and photometric consistency. The classification logic integrates data-driven learning models and physics-based geometric validation. Deep neural inference identifies subtle illumination patterns. Geometric back-projection validates whether the detected shadows correspond to plausible light paths. AI-based completion fills in uncertain or missing regions, such as reflective or transparent surfaces where depth data is unreliable. Once classification is complete, the system 108 generates a set of illumination descriptors representing the scene's lighting behavior. The illumination descriptors include light-direction vectors, source-intensity coefficients, diffusion values, and temporal-stability indices derived from recent frames.

The system 108 assigns a confidence score to each descriptor, computed from probabilistic outputs, temporal consistency, and geometric validation metrics. Low-confidence results trigger automatic re-evaluation or parameter adjustment to preserve visual reliability. The classified illumination descriptors are transmitted to the casting model 112.

The generation module 214 represents the first functional stage of the casting model 112. The generation module (214) generates illumination parameters based on the classification of the shadow-type scene. The generation module 214 converts the classified illumination context into measurable lighting descriptors representative of the real-world illumination characteristics. The generated illumination parameters define quantitative lighting behaviour. The one or more illumination parameters include the light direction, the intensity, the diffusion, and the color temperature.

In an embodiment, the generation module 214, upon receiving the classification output, computes corresponding illumination descriptors. For the first shadow-type scene, the generation module 214 calculates directional parameters such as azimuth angle, elevation angle, and direct-intensity coefficient derived from the detected shadow alignment and luminance contrast. For the second shadow-type scene, the generation module 214 computes diffusion coefficients, global ambient intensity, and scattering ratios representing distributed lighting conditions.

In another embodiment, the generation module 214 may apply a hybrid computation approach combining deterministic light-estimation equations and learned data-driven correction factors. The deterministic computation derives preliminary values for the luminance contrast, gradient entropy, and spatial uniformity of brightness. The learned model refines the parameters using context-specific correction factors retrieved from the database 114. The refinement accounts for variations caused by reflective materials, transient exposure shifts, or partial occlusions.

In an embodiment, the generation module 214 generates an illumination parameter map representing per-pixel or region-based lighting variations within the captured environment. Each cell within the map includes values corresponding to intensity, diffusion, and confidence indices computed from the classification certainty of the detected scene. The illumination parameter map serves as a structured dataset for guiding rendering and light adaptation of digital content. The illumination parameter map ensures that the mixed-reality rendering pipeline maintains consistent luminance and shadow alignment across diverse environmental conditions.

For example, when the classification output indicates a first shadow-type scene corresponding to a bright outdoor condition, the generation module 214 generates high-intensity, low-diffusion parameters aligned with the detected sunlight direction. Conversely, for a second shadow-type indoor environment, the generation module 214 generates uniform intensity and high diffusion parameters representing scattered illumination from multiple sources.

The positioning module 216 places, in a three-dimensional rendering environment, one or more light sources derived from the one or more illumination parameters. The positioning module 216 serves as the spatial initialization stage of the casting model 112 responsible for translating the computed illumination parameters into the corresponding virtual light entities within the 3D rendering environment. The placement of the one or more light sources replicates the geometric and photometric configuration of real-world illumination.

In an embodiment of the present disclosure, the positioning module 216 maps each illumination vector to a corresponding light entity characterized by direction, origin point, intensity, and color temperature. The positioning module 216 uses the camera calibration matrix and the depth map to determine the spatial coordinates of the light sources within the rendering environment. For instance, when the detected illumination corresponds to directional sunlight, the positioning module 216 positions a parallel light at an infinite distance along the estimated azimuth and elevation angles. In contrast, for diffused or ambient illumination, the positioning module 216 places multiple low-intensity point lights or a hemispherical environment light source to simulate isotropic scattering.

In another embodiment, the positioning module 216 dynamically adjusts light placement parameters based on device motion and camera pose variations. Using inertial measurement unit (IMU) data, the positioning module 216 maintains spatial coherence between virtual and real light orientation even as the user device (104) moves through the environment. The module also retrieves environmental boundaries from the depth map to ensure that light-source placement respects occlusion constraints, preventing unrealistic illumination overlaps or light penetration through solid surfaces.

The rendering module 218 renders, in the three-dimensional rendering environment, at least one digital object spatially aligned with the physical environment using positional coordinates obtained from the image. The rendering module 218 operates as the visual synthesis unit of the casting model 112. The rendering module 218 integrates the digital object geometry, materials, and lighting conditions within the reconstructed 3D scene. The rendering process ensures that each digital object appears spatially coherent and optically consistent with the physical surroundings captured by the user device 104.

In an embodiment, the rendering module 218 receives the one or more illumination parameters and the light-source parameters from the positioning module 216. In addition, the rendering module 218 receives the object geometry and anchor coordinates extracted from the image. The rendering module 218 positions the digital object in the 3D environment based on the derived camera pose and depth reference.

In another embodiment, the rendering module 218 dynamically adapts the rendering parameters such as exposure, color temperature, and tone-mapping curve based on real-time environmental changes. The rendering module 218 may incorporate ray-traced global illumination or shadow-mapping methods for accurate light transport simulation. The rendered output includes object shading, reflections, and highlights derived from the real-world lighting conditions represented by the one or more illumination parameters.

The casting module 220 cast one or more shadows of the at least one digital object within the rendered scene based on the one or more illumination parameters. The casting module 220 implements the shadow generation stage of the casting model (112). The casting module 220 simulates the interaction between the placed virtual light sources and the rendered digital object to reproduce realistic shadow behavior corresponding to the physical environment.

In an embodiment, the casting module 220 utilizes the one or more illumination parameters to project the one or more shadows consistent with the classified scene type. For the first shadow-type scene, the casting module 220 employs a directional shadow-mapping algorithm to generate crisp, high-contrast shadows with sharp boundaries. For the second shadow-type scene, the casting module 220 applies soft-shadow algorithms to create diffused and blurred shadow edges characteristic of ambient lighting.

In another embodiment, the casting module 220 adapts the shadow-casting behavior dynamically according to the surface geometry obtained from the depth map and the scene reconstruction data. The casting module 220 computes shadow-receiver surfaces, applies occlusion checks, and adjusts intensity fall-off based on the object distance and the light diffusion. The resulting shadows are encoded with geometric and photometric accuracy. Accordingly, the casting module 220 enables the mixed-reality rendering pipeline to achieve visually coherent and perceptually stable lighting integration.

The compositing module 222 is configured to composite the rendered scene with the image of the physical environment to generate an augmented image. The augmented image includes the at least one digital object and the one or more shadows. The compositing module 222 performs the final image fusion step that merges digitally rendered elements with the captured physical environment to produce a seamless mixed-reality frame.

In an embodiment, the compositing module 222 receives the rendered object frame and the shadow data from the casting module 220. The compositing module 222 blends the object and the one or more shadows with the original environment image. In an embodiment, the blending may be done using alpha blending, luminance-weighted fusion, or tone-preserving compositing algorithms. The compositing module 222 adjusts the transparency and intensity of digital shadows based on the corresponding ambient-light levels detected in the real scene.

In another embodiment, the compositing module 222 may perform depth-aware integration to determine occlusion relationships between real and virtual objects using the depth map. The integration enables the system 108 to correctly render scenarios where physical elements partially obstruct digital ones, ensuring realistic depth perception. In an embodiment, the compositing module 222 may apply temporal smoothing to minimize flicker between consecutive frames and gamma correction to maintain tonal coherence across lighting transitions.

Accordingly, the compositing module 222 generates the augmented image in which the at least one digital object and the casted one or more shadows appear naturally embedded within the physical environment. The resulting composite maintains accurate color, illumination, and spatial relationships, providing a perceptually consistent mixed-reality visualization for the user. In an embodiment, the compositing module 222 employs AI-based semantic segmentation to distinguish between foreground and background regions in the live feed. Semantic segmentation ensures that virtual shadows respect real-world geometry and do not violate spatial realism.

For collaborative mixed-reality experiences involving multiple users, the compositing module 222 maintains synchronized global lighting states across devices. In an example, when user A views a virtual object from one side and user B observes from another, both users perceive consistent shadow direction, softness, and intensity. The synchronization protocol ensures that shared mixed-reality scenes maintain common illumination references, even when rendered on heterogeneous hardware.

The output of the compositing module 222 represents the final harmonized mixed-reality frame, displayed on the user device 104. The output visually merges real-world and digital components under consistent lighting behavior, enabling the user 102 to perceive seamless coexistence between the physical and virtual domains. In an embodiment of the present disclosure, the compositing module 222 records anonymized illumination and rendering metadata, such as exposure maps, blending ratios, and scene classifications, into the database 114.

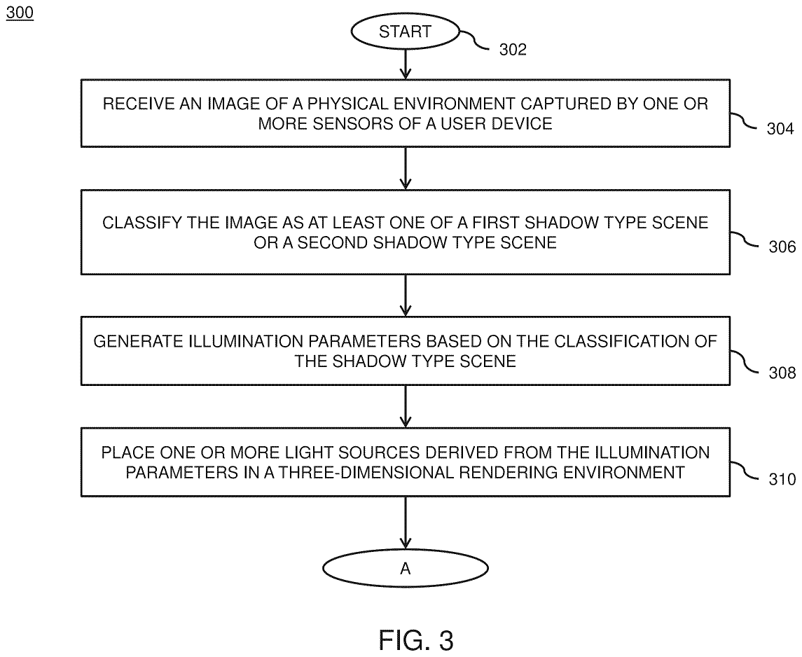

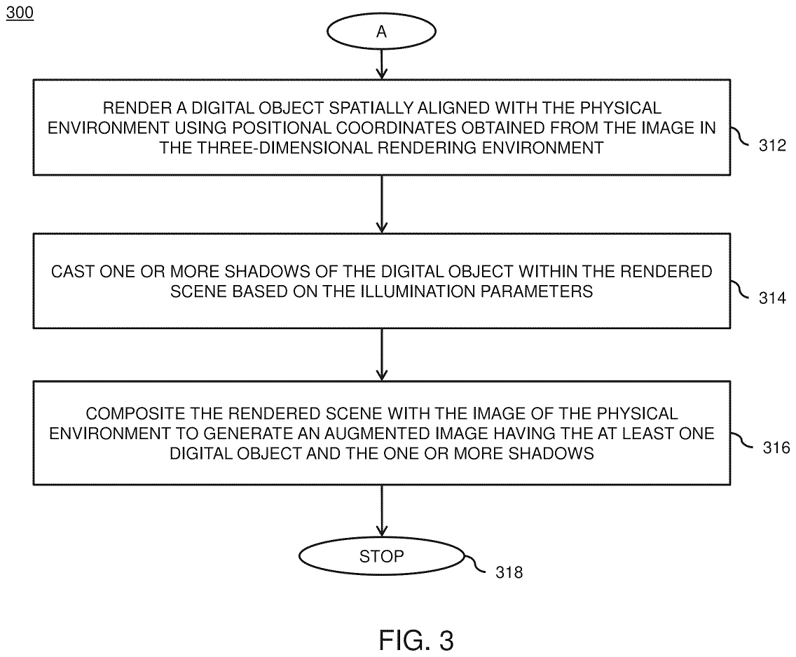

FIG. 3 illustrates a flowchart of a method 300 for performing the dynamic shadow casting in the mixed-reality environment, in accordance with various embodiments of the present disclosure. The method 300 may be implemented by the system 108 described with reference to FIGS. 1 and 2. The flowchart represents the operational sequence of the system 108 in performing real-time image analysis, illumination parameter generation, and photometrically consistent rendering.

The flowchart initiates at 302. At step 304, the method 300 includes receiving the image of the physical environment captured by the one or more sensors 104A of the user device 104. The user device 104 acquires the one or more image frames and the associated metadata from the one or more sensors 104A, which may include RGB, depth, LiDAR, or photometric sensors. The captured image represents the real-world scene surrounding the user 102. In an embodiment, the captured image data includes the photometric features such as brightness, exposure, and color temperature, and geometric features such as object contours and depth.

At step 306, the method 300 includes the classifying of the image as at least one of the first shadow-type scene or the second shadow-type scene. The system 108 performs the pixel-level analysis of the received image to identify the shadow regions and the illumination distributions. Based on the detected shadow geometry and the luminance variation, the system 108 determines whether the physical environment corresponds to the first shadow-type scene (direct or hard illumination, e.g., sunlight or spotlight) or the second shadow-type scene (diffused or ambient illumination, e.g., cloudy sky or indoor lighting). The classification defines the underlying lighting context for the subsequent computation of illumination parameters.

At step 308, the method 300 includes the generation of the one or more illumination parameters based on the classification of the shadow-type scene. Once the scene classification is established, the generation module 214 computes the one or more illumination parameters, such as the direction, the intensity, the diffusion coefficient, and the color temperature of the detected light sources. The system 108 utilizes the analytic geometry and the AI-based regression techniques to extract the directional light vectors and the photometric metrics from the image. For the first shadow-type scene, the one or more illumination parameters emphasize the directional illumination. For the second shadow-type scene, the system 108 derives the ambient-field characteristics using the HDRI-style environment mapping. The one or more illumination parameters form the SDRR (Shadow Direction, Diffusion, and Radiance) map are used for downstream 3D rendering.

At step 310, the method 300 includes the placing of the one or more light sources derived from the one or more illumination parameters in the three-dimensional rendering environment. The system 108 initializes the virtual rendering space that mirrors the physical environment's geometry and the spatial scale. The one or more synthetic light sources are positioned according to the direction vectors and the intensity values in the 3D rendering environment. The generation module 214 and the positioning module 216 collectively define the spatial coordinates and the angular orientations of the one or more light sources. The projected illumination aligns with the real-world light origin.

At step 312, the method 300 includes the rendering of the at least one digital object spatially aligned with the physical environment. The at least one digital object is rendered using the positional coordinates obtained from the image in the three-dimensional rendering environment. The rendering module 218 integrates the at least one digital object into the scene using anchor coordinates derived from the depth map and the positional data of the physical environment. The rendering module 218 constructs the 3D transformation matrix to align the pose, scale, and orientation of the at least one digital object with respect to the real-world surfaces. The rendering process applies the one or more illumination parameters to simulate the appropriate lighting response on a material of the at least one digital object.

At step 314, the method 300 includes the casting of the one or more shadows of the digital object within the rendered scene based on the one or more illumination parameters. The casting module 220 simulates the obstruction of light rays caused by the digital object and computes the corresponding shadow projection onto real or virtual surfaces. Using the SDRR map and 3D geometry of the at least one digital object, the casting module 220 generates self-shadows (falling on the object itself) and ground-shadows (projected onto surrounding surfaces). The system 108 dynamically updates the shadows in response to changes in the lighting or the position of at least one digital object. When multiple light sources are active, the casting module 220 combines the effects of the multiple sources through radiance-weighted blending to maintain physical accuracy.

At step 316, the method 300 includes the compositing of the rendered scene with the image of the physical environment to generate the augmented image. The augmented image includes the digital object and the one or more shadows. The compositing module 222 merges the rendered content with the live camera feed using the multi-layer blending techniques. The composite image integrates the at least one digital object, the real-world background, and the generated one or more shadows into a single harmonized visual frame. The casting module 220 performs the color correction and the tone-mapping to match the virtual layer's exposure with the real-world brightness. The semantic segmentation ensures that shadows are projected only onto valid physical surfaces. The resulting frame is rendered on the display of the user device 104, enabling the user 102 to perceive the at least one digital object as a natural part of the physical scene.

In an embodiment, the system 108 may re-evaluate the one or more illumination parameters and regenerate updated shadows and reflections in real time. The re-evaluation is done based on detection, by the one or more sensors 104A, of variations in ambient light, movement of physical objects, or user motion.

The flowchart 300 ends at step 318. The described sequence of steps enables accurate classification of environmental lighting, precise computation of the one or more illumination parameters, and physically coherent rendering of the at least one digital object and the corresponding shadows in the mixed-reality scene.

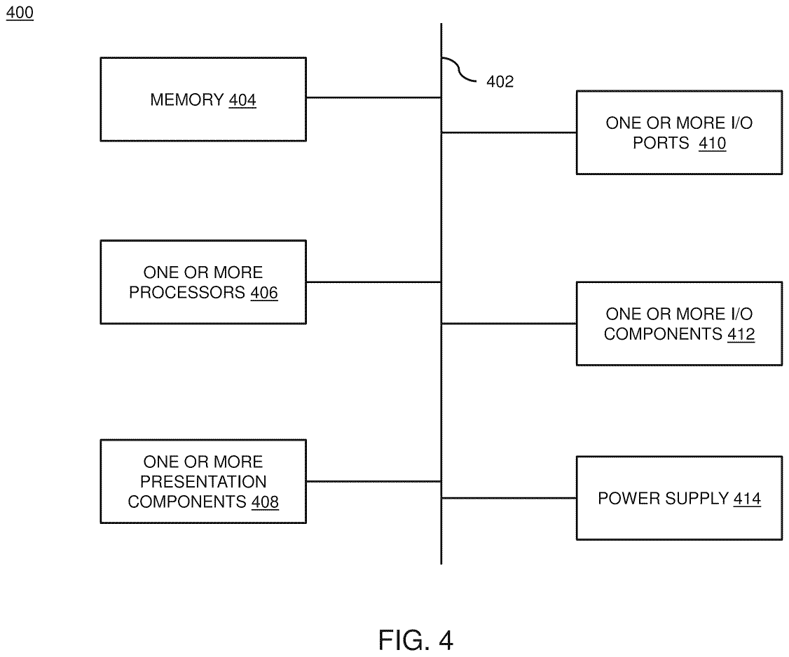

FIG. 4 illustrates a block diagram of an exemplary device 400 configured for executing the dynamic shadow casting and the illumination harmonization in real time, in accordance with various embodiments of the present disclosure. The device 400 is representative of the system 108 or any computing entity configured to operate the shadow-detection model 110, the casting model 112, and the associated analytical frameworks for real-time illumination estimation and rendering. The device 400 may be implemented as a non-transitory computer-readable storage medium storing instructions for detecting, classifying, and rendering the illumination-consistent shadows within the mixed-reality scene.

The device 400 includes a bus 402 that directly or indirectly couples a memory 404, one or more processors 406, one or more presentation components 408, one or more input/output (I/O) ports 410, one or more I/O components 412, and a power supply 414. The bus 402 represents one or more communication channels such as an address bus, a data bus, or a control bus that enable coordinated data transfer among the hardware elements during the real-time illumination modelling and rendering.

In practice, the boundaries between these components may overlap. For example, the processor 406 may incorporate integrated memory or an embedded neural-processing accelerator; likewise, a presentation component 408 may serve as an input device for user interaction. FIG. 4 therefore provides a logical abstraction of the physical hardware that collectively enables image acquisition, execution of the shadow-casting pipeline, and delivery of the harmonized output to the display surface.

The device 400 includes one or more types of computer-readable media accessible to the processor 406. Such media include volatile or non-volatile, removable or non-removable storage elements that maintain datasets, trained model parameters, SDRR illumination maps, and executable program instructions used by the shadow-detection and casting subsystems.

The computer-storage media may include random-access memory (RAM), read-only memory (ROM), flash memory, solid-state drives, or magnetic or optical disks capable of retaining data and instructions. Communication media may embody data or control signals in a modulated carrier transmitted through wired or wireless channels such as Wi-Fi 6, 5G, Bluetooth LE, or optical fiber links. These channels facilitate low-latency synchronization between the user device 104 and the system 108 for frame-level illumination updates.

The memory 404 stores computer-executable instructions that, when executed by the one or more processors 406, cause the device 400 to perform the complete illumination-analysis and casting cycle. The stored instructions enable the device 400 to capture environmental imagery, compute SDRR illumination parameters, generate 3D lighting configurations, render virtual content, and project physically coherent shadows within the composite scene. The memory 404 maintains temporal buffers, per-pixel depth tensors, and confidence maps to ensure temporal consistency during continuous rendering.

The one or more processors 406 execute the instructions stored in the memory 404 to perform both analytical and graphical operations required for shadow detection and casting. The one or more processors 406 may include central processing units (CPUs) for control and coordination, graphics processing units (GPUs) for real-time rasterization and light-ray simulation, and neural or tensor processing units (NPUs/TPUs) for executing AI-based illumination-estimation models. The CPUs orchestrate scene classification and data flow, while the GPUs and NPUs jointly implement the SDRR map generation, ray-tracing, and shadow-projection routines.

The one or more presentation components 408 generate perceptible output for the user 102. These components may include a handheld device display, a head-mounted display (HMD), or a smart-glasses visor that renders digital content merged with real-world imagery. The presentation layer displays the composited output generated by the casting and compositing modules (220 and 222), allowing the user to perceive self-shadows and ground-shadows aligned with the detected environmental lighting. The resulting visualization preserves photometric coherence even as the user moves or lighting conditions change.

The one or more I/O ports 410 and the I/O components 412 enable the exchange of data between the device 400, the user device 104, and the network 106. The I/O components 412 may include RGB or multispectral cameras, depth sensors, LiDAR scanners, ambient-light sensors, photometric detectors, microphones, or inertial-measurement units (IMUs) that capture visual, spatial, and motion data describing the surrounding scene. The synchronization of these sensor streams allows the system 108 to reconstruct accurate lighting geometry and maintain shadow alignment across frames. The one or more I/O ports 410 further support wired or wireless data channels to ensure high-bandwidth connectivity for real-time inference and rendering.

The power supply 414 provides electrical energy for continuous operation of the device 400. The power supply 414 may include rechargeable batteries, AC/DC converters, or hybrid power sources. Intelligent power-management circuitry dynamically allocates resources across CPUs, GPUs, and NPUs based on computational load, ensuring thermal stability and extended operational endurance during real-time rendering.

During operation, the one or more processors 406, the memory 404, and the I/O components 412 function cooperatively in a continuous feedback loop. The sensors capture environmental data, which flows through the bus 402 into memory 404, where the one or more processors 406 execute the shadow-detection model 110 to derive luminance, chromaticity, and depth-based illumination features. The casting model 112 consumes the features to compute the SDRR illumination maps and project the corresponding shadows within a three-dimensional rendering space. The generated illumination descriptors are transmitted to the presentation components 408 for visualization or to external rendering systems for extended scene composition.

In an embodiment of the present disclosure, the device 400 generates self-shadows and ground-shadows. The system 108 generates the shadows using the 3D model geometry of the object and the SDRR illumination parameters. The process enables natural light behavior, where shadow orientation, diffusion, and edge softness correspond accurately to real-world lighting.

The device 400 includes a real-time compositing engine that fuses rendered digital elements, detected shadows, and physical-scene imagery. The engine performs color correction, tone-mapping, and depth-aware blending to eliminate brightness discontinuities between virtual and real regions. The result is a perceptually seamless frame that maintains global lighting coherence and realistic shadow integration.

In another embodiment, the device 400 supports multi-user synchronization. Multiple users operating independent user devices can simultaneously view or interact with the same mixed-reality scene. The device 400 shares the one or more illumination parameters, the object coordinates, and the shadow maps over the network 106 to ensure that each participant perceives identical lighting behavior. The collaborative mode enables consistent co-creation or training environments under shared photometric conditions.

The device 400 can operate in a distributed hybrid configuration wherein computation-intensive rendering tasks, such as volumetric illumination modeling, ray-traced shadow harmonization, or temporal-consistency correction are offloaded to cloud or edge nodes. Latency-sensitive modules, such as real-time compositing and positional alignment, continue to execute locally on the device 400. The hybrid arrangement improves scalability, minimizes delay, and optimizes resource utilization across heterogeneous hardware.

Collectively, the components and subsystems of the device 400 form an integrated computational framework for performing illumination-aware analysis and 3D shadow casting in mixed-reality environments. The described architecture enables accurate detection, photometric interpretation, and rendering of dynamic shadows that remain consistent with real-world lighting, thereby achieving visual realism and temporal stability for single-or multi-user experiences.

The present disclosure provides a system and method for dynamic shadow casting and illumination harmonization in mixed-reality environments, offering a transformative improvement in how digital content interacts with real-world lighting conditions. The invention achieves real-time synchronization of physical and virtual illumination through a hybrid AI-driven framework that integrates shadow detection, SDRR-based illumination mapping, and intelligent 3D shadow projection. By leveraging both geometric (depth-based) and photometric (luminance and chrominance) cues from the user's physical environment, the system 108 generates realistic self-shadows and ground-shadows for virtual objects that dynamically adapt to environmental changes such as time of day, movement of light sources, or user motion. The result is a perceptually coherent and photometrically accurate mixed-reality experience that maintains visual realism across continuously changing conditions without manual calibration or pre-defined light settings.

Further, the invention offers scalability, adaptability, and cross-device consistency, enabling collaborative multi-user interaction within shared illumination spaces. The distributed architecture allows computationally intensive tasks, such as volumetric illumination modeling or shadow harmonization, to be performed on edge or cloud servers while latency-sensitive rendering and compositing occur locally. This hybrid configuration ensures low latency, high visual fidelity, and efficient power utilization across diverse devices. The modular design of the system enables integration with various rendering engines and mixed-reality platforms, while the use of AI-enhanced illumination estimation ensures robustness under complex lighting conditions including multi-source, diffused, or reflective environments. Collectively, the invention bridges the perceptual gap between real and virtual domains, setting a new benchmark for realism and interactivity in augmented and mixed-reality applications.

The present invention is described hereinafter by various embodiments. The invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only, and are not intended to limit the scope of the claims. In addition, a number of system architectures are identified as suitable for various facets of the implementations. These system architectures are to be treated as exemplary and are not intended to limit the scope of the invention.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

What is claimed is:

1. A system for performing illumination-aware rendering based on real-world shadow analysis, the system comprising:
one or more processors; and
a non-transitory memory communicatively coupled to the one or more processors, wherein the memory stores instructions that, when executed by the one or more processors, cause the system to:
receive, using a receiving module, one or more images of a physical environment captured by one or more sensors of a user device;
analyze, using an analysis module, the one or more images to derive one or more features representative of lighting, texture, and spatial composition;
classify, using a classification module, at least one of the one or more images into one of a first shadow-type scene or a second shadow-type scene;
generate, using a generation module, one or more illumination parameters based on the classification of the shadow-type scene, wherein the one or more illumination parameters define at least a direction, intensity, and diffusion of one or more light sources;
place, using a positioning module, in a three-dimensional rendering environment, one or more light sources derived from the one or more illumination parameters;
render, using a rendering module in the three-dimensional rendering environment, at least one digital object spatially aligned with the physical environment using positional coordinates obtained from the image;
cast, using a casting module, one or more shadows of the at least one digital object within the three-dimensional rendering environment based on the one or more illumination parameters; and
composite, using a compositing module, the rendered three-dimensional environment with the image of the physical environment to generate an augmented image comprising the at least one digital object and the one or more shadows.

2. The system of claim 1, wherein the first shadow-type scene corresponds to directional illumination producing hard shadows, and the second shadow-type scene corresponds to diffused illumination producing soft shadows.

3. The system of claim 1, wherein the classification of the shadow-type scene is based on at least one of luminance contrast, edge sharpness, or gradient entropy.

4. The system of claim1, wherein the one or more illumination parameters comprise at least one of a light direction vector, a diffusion coefficient, a brightness ratio, or a color temperature value.

5. The system of claim 1, wherein the generating of the one or more illumination parameters comprises performing geometric correlation between shadow boundaries and corresponding light vectors derived from a depth map.

6. The system of claim 1, wherein the placing of the one or more light sources comprises assigning spatial coordinates in the three-dimensional rendering environment based on the one or more illumination parameters and a physical orientation of the user device (104).

7. The system of claim 1, wherein the rendering of the at least one digital object comprises applying material-aware shading and reflection properties based on the one or more illumination parameters.

8. The system of claim 1, wherein the casting of the one or more shadows comprises simulating self-shadows and ground shadows of the at least one digital object using the classified illumination type.

9. The system of claim 1, wherein the compositing of the rendered three-dimensional environment with the image of the physical environment comprises blending pixel values using alpha masking and tone-mapped color alignment.

10. The system of claim 1, wherein the system dynamically updates the one or more illumination parameters and re-renders the augmented image in response to real-time lighting changes detected through the one or more sensors.

11. A computer implemented method for performing illumination-aware rendering based on real-world shadow analysis, the computer-implemented method comprising:
receiving one or more images of a physical environment captured by one or more sensors of a user device;
analysing the one or more images to derive one or more features representative of lighting, texture, and spatial composition;
classifying at least one of the one or more images into one of a first shadow-type scene or a second shadow-type scene;
generating one or more illumination parameters based on the classification of the shadow-type scene, wherein the one or more illumination parameters define at least a direction, intensity, and diffusion of one or more light sources;
placing, in a three-dimensional rendering environment, one or more light sources derived from the one or more illumination parameters;
rendering, in the three-dimensional rendering environment, at least one digital object spatially aligned with the physical environment using positional coordinates obtained from the image;
casting one or more shadows of the at least one digital object within the three-dimensional rendering environment based on the one or more illumination parameters; and
compositing the rendered three-dimensional environment with the image of the physical environment to generate an augmented image comprising the at least one digital object and the one or more shadows.

12. The computer-implemented method of claim 11, wherein the first shadow-type scene corresponds to directional illumination producing hard shadows, and the second shadow-type scene corresponds to diffused illumination producing soft shadows.

13. The computer-implemented method of claim 11, wherein classifying the at least one image into the shadow-type scene is based on at least one of luminance contrast, edge sharpness, or gradient entropy.

14. The computer-implemented method of claim 11, wherein the one or more illumination parameters comprise at least one of a light direction vector, a diffusion coefficient, a brightness ratio, or a color temperature value.

15. The computer-implemented method of claim 11, wherein generating the one or more illumination parameters comprises performing geometric correlation between shadow boundaries identified in the one or more images and corresponding light vectors derived from a depth map.

16. The computer-implemented method of claim 11, wherein placing the one or more light sources comprises assigning spatial coordinates within the three-dimensional rendering environment based on the one or more illumination parameters and a physical orientation of the user device.

17. The computer-implemented method of claim 11, wherein rendering the at least one digital object comprises applying material-aware shading and reflection properties based on the one or more illumination parameters.

18. The computer-implemented method of claim 11, wherein casting the one or more shadows comprises simulating self-shadows and ground shadows of the at least one digital object using the classified shadow-type scene.

19. The computer-implemented method of claim 11, wherein compositing the rendered three-dimensional environment with the at least one image of the physical environment comprises blending pixel values using alpha masking and tone-mapped color alignment.

20. A non-transitory computer-readable medium storing instructions that, when executed by one or more processors, cause a system to perform a method for performing illumination-aware rendering based on real-world shadow analysis, the method comprising:
receiving one or more images of a physical environment captured by one or more sensors of a user device;
analysing the one or more images to derive one or more features representative of lighting, texture, and spatial composition;
classifying at least one of the one or more images into one of a first shadow-type scene or a second shadow-type scene;
generating one or more illumination parameters based on the classification of the shadow-type scene, wherein the one or more illumination parameters define at least a direction, intensity, and diffusion of one or more light sources;
placing, in a three-dimensional rendering environment, one or more light sources derived from the one or more illumination parameters;
rendering, in the three-dimensional rendering environment, at least one digital object spatially aligned with the physical environment using positional coordinates obtained from the image;
casting one or more shadows of the at least one digital object within the three-dimensional rendering environment based on the one or more illumination parameters; and
compositing the rendered three-dimensional environment with the image of the physical environment to generate an augmented image comprising the at least one digital object and the one or more shadows.
